(19) United States
(12) Patent Application Publication
(10) Pub. No.: US 2016/0237902 A1
(43) Pub. Date: Aug. 18, 2016

(54) GAS TURBINE INLET AIR CONDITIONING COIL SYSTEM

(71) Applicants: Jianmin ZHANG, Greenville, SC (US); Bradly Aaron KIPPEL, Greenville, SC (US); Yongjiang HAO, Shanghai (CN); Douglas Scott BYRD, Greenville, SC (US); Hua ZHANG, Greenville, SC (US); General Electric Company, Schenectady, NY (US)

(72) Inventors: Jianmin Zhang, Creer, SC (US); Brady Aaron Kippel, Greenville, SC (US); Yongjiang Hao, Shanghai (CN); Douglas Scott Byrd, Creer, SC (US); Hua Zhang, Creer, SC (US)

(21) Appl. No.: 14/768,428

(22) PCT Filed: Nov. 5, 2013
(86) PCT No.: PCT/CN2013/086545

§ 371 Date: Aug. 17, 2015

(51) Int. Cl. F02C 7/143; F02C 7/057

(52) U.S. Cl. CPC F02C 7/143; F02C 7/057; F05D 2220/32; F05D 2260/20

(57) ABSTRACT

A system includes a gas turbine system, including an air intake system that includes a housing, a first plurality of air conditioning coils, a second plurality of air conditioning coils that is downstream relative to the first plurality, and a baffle extending between each of the first and second pluralities of air conditioning coils, wherein the baffle is configured to direct an air flow through the first or second pluralities of air conditioning coils in a closed position, and the baffle is configured to enable air flow to bypass the first and second pluralities of coils in an opened position.

### CROSS-REFERENCE TO RELATED APPLICATIONS

This application claims priority from and the benefit of PCT Application No. PCT/CN2013/086545, filed on Nov. 5, 2013, entitled “Gas Turbine Inlet Air Conditioning Coil System,” which is herein incorporated by reference in its entirety.

### BACKGROUND OF THE INVENTION

The subject matter disclosed herein relates to gas turbine systems, and, more particularly, to an air conditioning coil system for a gas turbine compressor.

Gas turbine systems generally include a compressor, a combustor, and a turbine. The compressor compresses air from an air intake, and subsequently directs the compressed air to the combustor. In the combustor, the compressed air received from the compressor is mixed with a fuel and is combusted to create combustion gases. The combustion gases are directed into the turbine. In the turbine, the combustion gases pass across turbine blades of the turbine, thereby driving the turbine blades, and a shaft to which the turbine blades are attached, into rotation. The rotation of the shaft may further drive a load, such as an electrical generator, that is coupled to the shaft. The temperature of the air supplied to the air intake may affect the performance of the gas turbine system. For example, high temperatures lower the air density, thereby decreasing the mass flow rate of air entering the compressor, which reduces the efficiency and output of the gas turbine system.

### BRIEF DESCRIPTION OF THE INVENTION

Certain embodiments commensurate in scope with the originally claimed invention are summarized below. These embodiments are not intended to limit the scope of the claimed invention, but rather these embodiments are intended only to provide a brief summary of possible forms of the invention. Indeed, the invention may encompass a variety of forms that may be similar to or different from the embodiments set forth below.

In a first embodiment, a system includes a gas turbine system, including an air intake system that includes a housing, a first plurality of air conditioning coils, a second plurality of air conditioning coils that is downstream relative to the first plurality, and a baffle extending between each of the first and second pluralities of air conditioning coils, wherein the baffle is configured to direct an air flow through the first or second pluralities of air conditioning coils in a closed position, and the baffle is configured to enable air flow to bypass the first and second pluralities of coils in an opened position.

In a second embodiment, a system includes an air intake system, including a first plurality of air conditioning coils at a first axial position, a second plurality of air conditioning coils positioned at a second axial position, downstream from the first, and a baffle extending between the first plurality of air conditioning coils and the second plurality of air conditioning coils, wherein the baffle is configured to enable the air flow to bypass the first and second pluralities of air conditioning coils in an opened position.

In a third embodiment, a gas turbine system includes a compressor, an air intake system including a first plurality of air conditioning coils at a first axial position, a second plurality of air conditioning coils positioned at a second axial position, downstream from the first, and a baffle extending between the first plurality of air conditioning coils and the second plurality of air conditioning coils, wherein the baffle is configured to enable the air flow to bypass the first and second pluralities of air conditioning coils in an opened position.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 is a schematic block diagram of an embodiment of a gas turbine system;

FIG. 2 is a schematic of an embodiment of an air conditioning coil system, which may be included in the gas turbine system of FIG. 1;

FIG. 3 is a schematic cross-sectional diagram of an embodiment of an air conditioning coil system with closed baffles;

FIG. 4 is a schematic cross-sectional diagram of an embodiment of an air conditioning coil system with open baffles;

FIG. 5 is a perspective view of an embodiment of an air conditioning coil system with closed baffles;

FIG. 6 is a perspective view of an embodiment of an air conditioning coil system with open baffles;

FIG. 7 is a perspective view of an embodiment of an air conditioning coil system arrangement;

FIG. 8 is a perspective view of an embodiment of an air conditioning coil system arrangement; and

FIG. 9 is a perspective view of an embodiment of an air conditioning coil system arrangement.

### DETAILED DESCRIPTION OF THE INVENTION

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements.

The disclosed embodiments include a system and method for allowing inlet oxidant to pass through and/or bypass air conditioning coils in a gas turbine system. The air conditioning coils may include cooling coils, heating coils, or any other conditioner coils. In the discussion below, the air conditioning coils are described as cooling coils as one non-limiting example, but it is recognized that any air conditioning coils may be used. Furthermore, when reference is made to cooling air, it is understood that cooling is used as one non-limiting example of a type of air conditioning. Likewise, the oxidant may include air, oxygen, oxygen-enriched air, oxygen-reduced air, or any combination thereof. In the following discussion, the oxidant is described as air as one non-limiting example, but is intended to cover all oxidants. As described below, the disclosed embodiments may include movable sets of baffles, which may be opened or closed to allow inlet air to bypass or pass through cooling coils of an air inlet system. In this manner, cooling coils may not need to be moved into or out of the air intake system when changing from a cooling mode to a non-cooling mode, and vice versa. As discussed in detail below, in certain embodiments, the system may have at least two sets of cooling coils with a plurality of baffles extending between them. The baffles may be opened to enable air to bypass the cooling coils (e.g., in a non-cooling mode), and the baffles may be closed to direct air through the cooling coils (e.g., in a cooling mode). When in a non-cooling mode, such as during a cooler season (e.g., winter), it may be desirable to reduce the resistance caused by cooling coils to the airflow entering the compressor, which may directly affect turbine efficiency. In certain embodiments, the pressure drop across a gas turbine inlet system may be between approximately 1 and 10 inches of water column (about 2.54 to about 25.4 centimeters of water). This may include the pressure drop across an inlet cooling system, which varies from approximately 0.25 inches to approximately 2.0 inches of water column (about 0.64 to about 5.08 centimeters of water). Depending on the size of the cooling coil, the value of this pressure drop may affect the gas turbine performance and efficiency. Thus, bypassing the cooling coils via movable baffles may enable a lower pressure drop than the level with no air bypassing, thereby improving the efficiency of the gas turbine system and reducing operation costs.

The cooling coil system may include a first plurality and a second plurality of cooling coils. For example, the second plurality may be located downstream relative to the first plurality, with one or more baffles extending between each of the first and second pluralities of cooling coils. When the baffles are closed, the baffles may direct an air flow through the first plurality or second plurality of cooling coils, thereby enabling cooling of the air flow. Alternatively, the baffles may be open, enabling air to either go through the coils or bypass them. This bypassing air leads to a lower pressure drop than the level with no air bypassing the cooling coils.

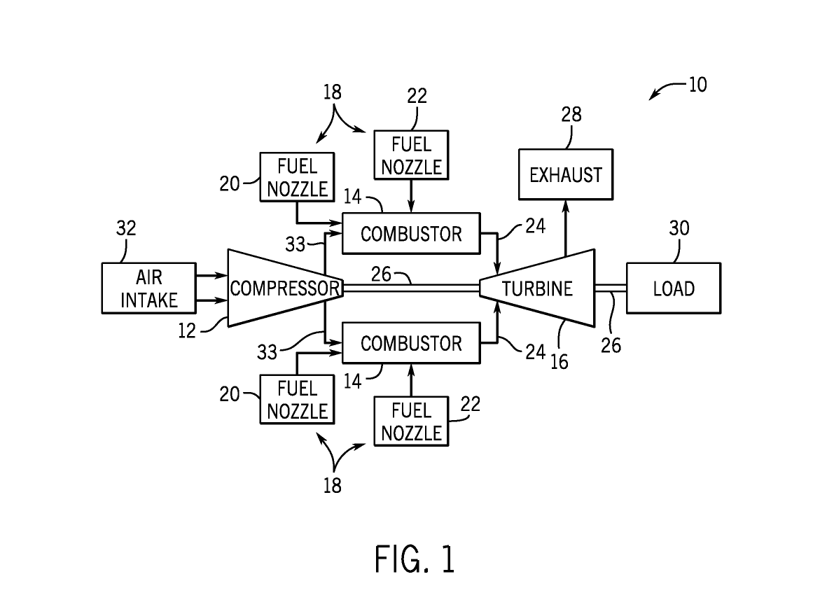

Turning now to the drawings, FIG. 1 illustrates a block diagram of an embodiment of a gas turbine system 10. The diagram includes a compressor 12, turbine combustors 14, and a turbine 16. The turbine combustors 14 include fuel nozzles 18 which route a liquid fuel and/or gas fuel, such as natural gas or syngas, into the turbine combustors 14. As shown, each turbine combustor 14 may have multiple fuel nozzles 18. More specifically, the turbine combustors 14 may each include a primary fuel injection system having primary fuel nozzles 20 and a secondary fuel injection system having secondary fuel nozzles 22.

The turbine combustors 14 ignite and combust an air-fuel mixture to create hot pressurized combustion gasses 24 (e.g., exhaust), which are subsequently directed into the turbine 16. Turbine blades are coupled to a shaft 26, which is also coupled to several other components throughout the turbine system 10. As the combustion gases 24 pass through the turbine blades in the turbine 16, the turbine 16 is driven into rotation, which causes the shaft 26 to rotate. Eventually, the combustion gases 24 exit the turbine system 10 via an exhaust outlet 28. Further, the shaft 26 may be coupled to a load 30, which is powered via rotation of the shaft 26. For example, the load 30 may be any suitable device that may generate power via the rotational output of the turbine system 10, such as a power generation plant or an external mechanical load. For instance, the load 30 may include an electrical generator, a propeller of an airplane, and so forth.

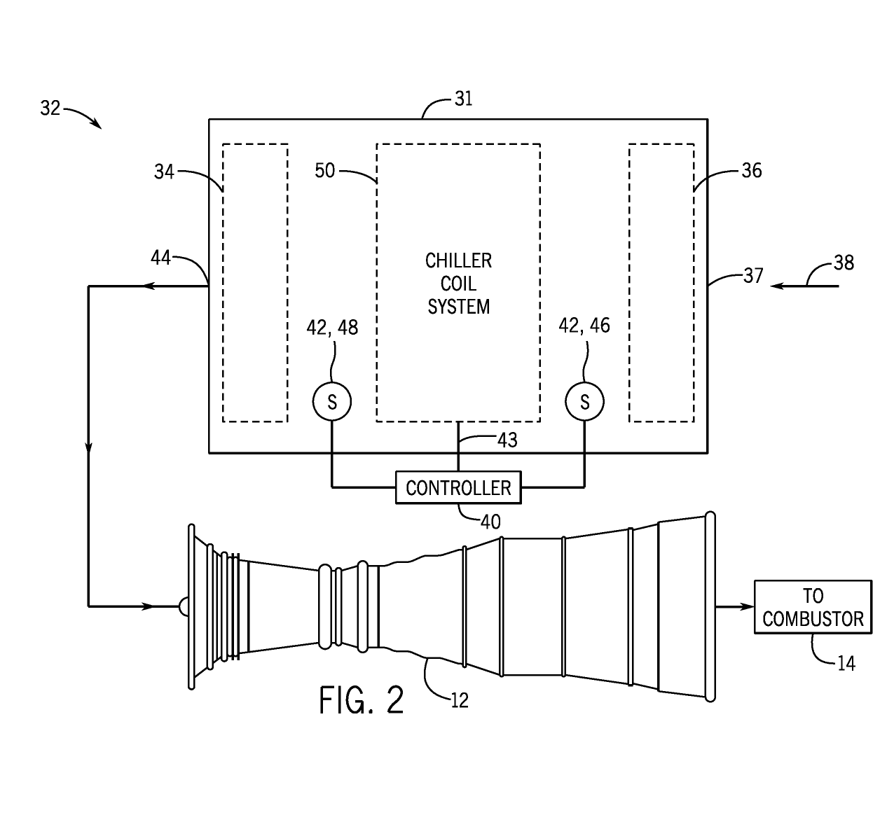

In an embodiment of the gas turbine system 10, compressor blades are included as components of the compressor 12. The blades within the compressor 12 are coupled to the shaft 26, and will rotate as the shaft 26 is driven to rotate by the turbine 16, as described above. The rotation of the blades within the compressor 12 causes compression of air from an air intake 32, thereby creating pressurized air 33. In certain hot environments, the air intake 32 may include a system to chill inlet air (described in more detail in FIG. 2) in order to increase its density, thereby increasing the mass flow rate of the pressurized air 33. The pressurized air 33 is then fed into the fuel nozzles 18 of the combustors 14. The fuel nozzles 18 mix the pressurized air 33 and fuel to produce a suitable mixture ratio for combustion (e.g., a combustion that causes the fuel to more completely burn) so as not to waste fuel or cause excess emissions.

FIG. 2 is a schematic showing an embodiment of the air intake system 32 and the compressor 12 in more detail. As shown, an air intake system housing 31 encloses the air intake system 32, which includes a drift eliminator 34, a chiller coil system 50, an air filter 36, and a controller 40 with sensors 42. An air flow 38 flows into the air intake system 32 at air inlet 37, and through air filter 36. While in this embodiment the air filter 36 is disposed upstream of the chiller coil system 50, it is understood that in certain applications, it may be desirable to place the air filter 36 downstream of the chiller coil system. The air filter 36 may be configured to limit the intake of dust, debris, and other particulate into the gas turbine engine 10 as a whole. From the air filter 36, the air flow 38 then flows downstream to the chiller coil system 50. The chiller coil system 50 chills the air, which increases its density and therefore its mass flow rate. Since the system 10 may be limited by its volumetric flow rate capacity, increasing the mass flow rate of the air 38 may increase the efficiency and power output of the gas turbine system 10. Once chilled, the air flow 38 may through the drift eliminator 34. The drift eliminator 34 may be configured to reduce the amount of water that is condensed out of the air flow 38 and carried over from the chiller coil system 50. The drift eliminator 34 may maintain drift rates within a desired range, for example between approximately 0.001% and 0.005% of the circulating flow rate. To this end, the drift eliminator 34 may function by providing multiple directional changes of the air flow 38 while blocking the escape of water droplets. In certain embodiments, such as when a non-condensing chiller coil system is employed or when the chiller coil system 50 is replaced by a heating coil system, the drift eliminator may be optional and/or may be removed. After passing through the drift eliminator 34, the air flow 38 exits the air intake system 32 at a point 44 that is generally opposite air inlet 37. The air flow 38 then passes to the compressor 12, and continues to the combustor 14.

As will be appreciated, a controller 40 may regulate the air intake system 32 and, more specifically, the chiller coil system 50, based on feedback from various sensors 42 of the air intake system 32. The controller may include an activator or drive to move the baffles 56 (e.g., an electric motor or drive, a pneumatic actuator, a hydraulic actuator, etc.). For example, the air intake system 32 may include sensors 42 that measure temperature, pressure, flow rate, or other operating parameter of the air flow 38. These sensors 42 may be located upstream and/or downstream of the chiller coil system 50 in the air intake system 32, such that measurements from two or more locations may be compared and the operation of the chiller coil system 50 may be adjusted as appropriate. For example, a sensor 42 upstream of the chiller coil system 50 (e.g., sensor 48) may measure a first temperature and compare it with a second temperature measured downstream of the chiller coil system 50 (e.g., by a sensor 48). Using these temperatures, the controller 40 may monitor and control the cooling effect of the chiller coil system 50 by controlling the coolant flow and temperature. If the upstream environment temperature is or is not within a certain range, the controller 40 may send a signal 43 to switch the chiller coil system 50 from a cooling mode to a non-cooling mode, or vice versa.

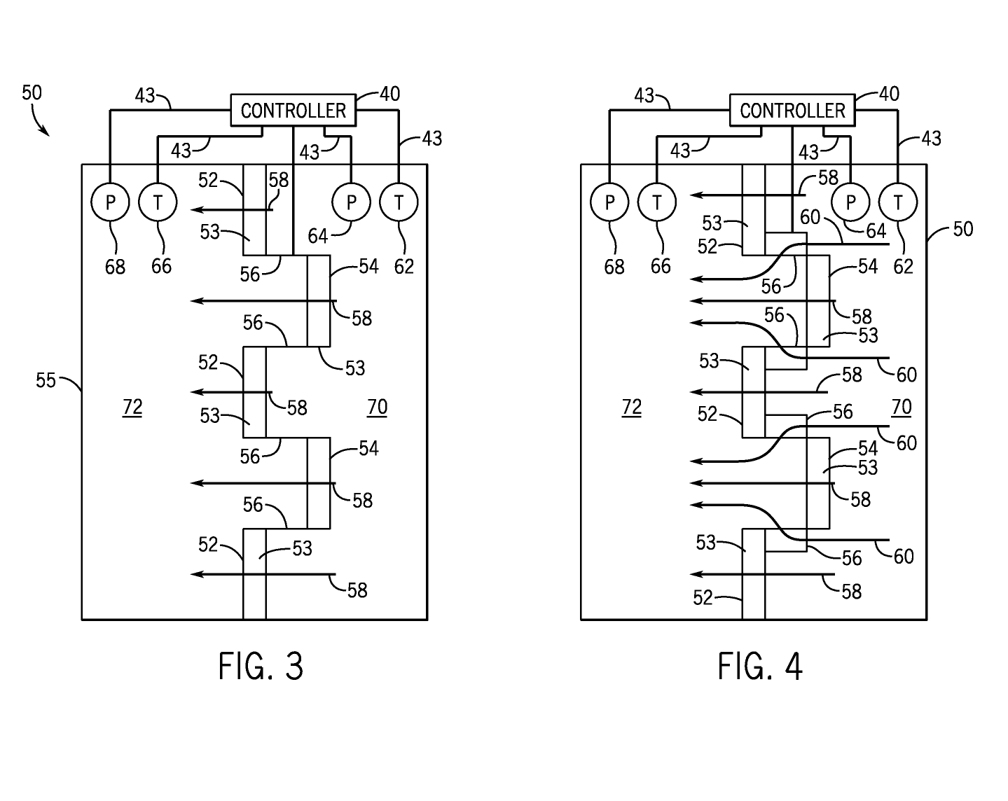

FIG. 3 is a schematic of an embodiment of the chiller coil system 50. The illustrated embodiment comprises two pluralities of cooler coils 53. Specifically, a downstream plurality of cooling coils (e.g., chiller coils, evaporator coils) 52 and an upstream plurality of cooling coils 54 are located within a chiller coil system housing 55. The downstream plurality of cooling coils 52 may be staggered relative to the upstream plurality of cooling coils 54 in the direction of the air flow 58. The cooling coils 53 (e.g., coils 52 and 54) may also be referred to as chiller coils, evaporator coils, or air conditioning coils. In this embodiment, the downstream plurality of cooling coils 52 includes three cooling coils 53, and the upstream plurality of cooling coils 54 includes two cooling coils 53, but they each may include any suitable number of coils 53. Baffles 56 extend between each of the first and second pluralities of cooling coils 52 and 54. The baffles 56 may be closed, as shown in FIG. 3, to direct all inlet air flow 58 through the cooling coils 53, or may open to enable the air flow 58 to bypass the coils 53, as shown in FIG. 4 and discussed below.

In the illustrated embodiment, the controller 40 is configured to regulate the operation of the baffles 56 based on measurements from various sensors 42 (shown in FIG. 2), which may include a temperature sensor 62 and a pressure sensor 64 on an upstream side 70 of the cooling coils 53, and a temperature sensor 66 and a pressure sensor 68 on a downstream side 72 of the cooling coils 53. The controller 40 may also include flow rate sensors, relative humidity sensors, etc., which may be used to regulate operation of the baffles 56. These various sensors 42 may send or receive signals 43 to and from the controller 40. In certain embodiments, based at least in part on information from these sensors 42, the controller 40 may be configured to rotate, turn, pivot, flex, fold or otherwise move the baffles 56 from an open position to a closed position, or vise versa, in order to improve compressor 12 efficiency. For example, the controller 40 may calculate a temperature drop from the upstream side 70 to the downstream side 72. If the temperature drop is under a certain established (e.g., threshold) value, the controller 40 may change the chiller coil system 50 to a non-cooling mode. That is, the controller 40 may open the baffles 56 in order to reduce the pressure drop across the cooling coils 53. Alternatively, the controller 40 may display or otherwise relay information to an operator, who may manage or adjust the baffles 56 manually. The baffles 56 may be positioned to be completely open, completely closed, or any suitable position in between. This flexibility increases operational flexibility and may lead to better response to environmental conditions and the needs of the gas turbine system 10. Additionally, the movable baffles 56 allow the chiller coil system 50 to easily switch from a cooling to a non-cooling mode, and vice versa, without sacrificing efficiency caused by a large pressure drop or requiring equipment changes that may be time consuming or labor-intensive.

Alternatively, the baffles 56 within the embodiment of the chiller coil system 50 shown in FIG. 3 may be open, as shown in the schematic of FIG. 4. When open, the baffles 56 enable the air flow 58 to pass through either the upstream plurality of cooling coils 54, the downstream plurality of cooling coils 52, or pass through flow paths 60 previously blocked by the baffles 56. These additional flow paths 60 may reduce the pressure drop caused by the cooling coils 53, as they allow more air to flow from the upstream side 70 to the downstream side 72 of the chiller coil system 50 while the cooling coils 52 and 54 remain in place. The use of the air bypass baffles 56 minimizes the air inlet system resistance by providing additional flow paths 60, which pass between the upstream plurality of cooling coils 54 and the downstream plurality of cooling coils 52. Additionally, the air flow 58 may continue to penetrate the cooling coils 53 even when the cooling coil system 50 is in non-cooling mode. As will be appreciated, the additional flow area provided by flow paths 60 may decrease the pressure drop from the upstream side 70 to the downstream side 72, thereby increasing the efficiency of the compressor 12 when the chiller coil system 50 is in non-cooling mode. In certain embodiments, the baffles 56 may be attached to the cooling coils, the chiller coil housing 55, or some other apparatus within the chiller coil system 50 via one or multiple hinges, a flexible or foldable material, or any other attachment mechanism that allows the baffle or baffles 56 to rotate, turn, pivot, flex, fold, or otherwise move between a position that blocks bypass flow paths 60 and a position that opens bypass flow paths 60.

As in FIG. 3, the chiller coil system 50 of FIG. 4 may include the controller 40 with upstream temperature sensor 62, upstream pressure sensor 64, downstream temperature sensor 66, and downstream pressure sensor 68. As described in detail above, the controller 40 may calculate a temperature or pressure drop across the cooling coils 53 (e.g., from the upstream side 70 to the downstream side 72). Based on signals 43 from the various sensors, the controller 40 may be configured to alter the position of the baffles 56 automatically, or may relay this information to an operator, who may manage the baffles 56 manually or using the controller 40.

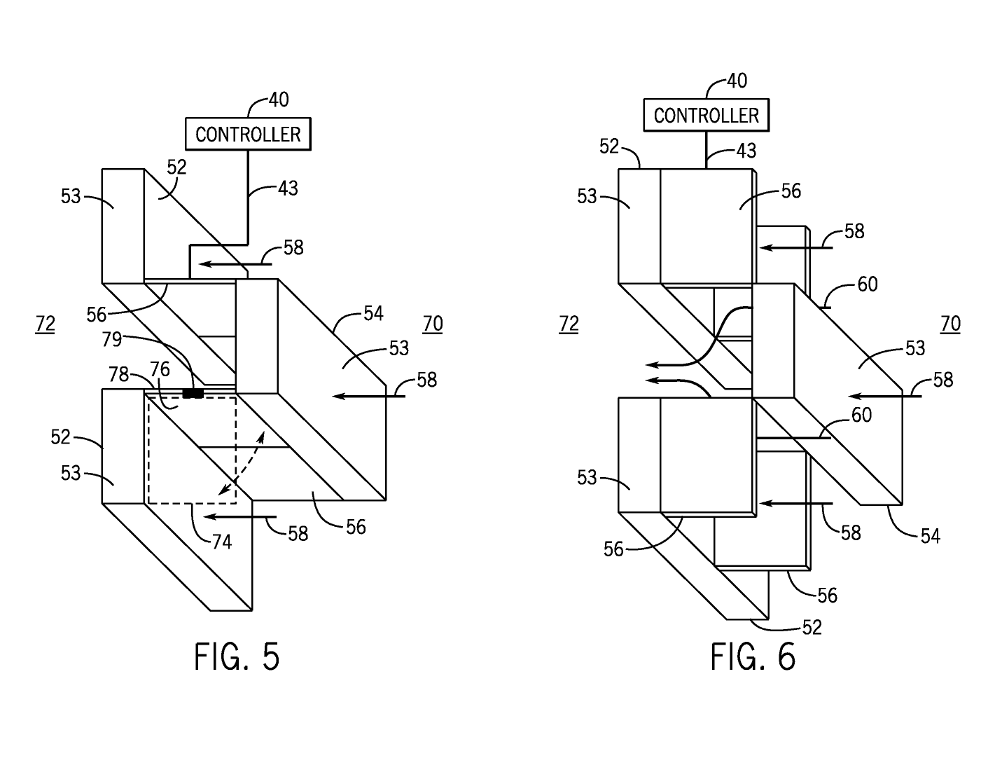

FIG. 5 is a perspective view of a partial embodiment of the chiller coil system 50. In the illustrated embodiment, the upstream plurality of cooling coils 54 includes one cooling coil 53, and the downstream plurality of cooling coils 52 contains two cooling coils 53. As in previously discussed embodiments, inlet air flow 58 passes from the upstream side 70 to the downstream side 72. The baffles 56 between the upstream cooling coil 54 and the downstream cooling coils 52 are shown in a position that directs the air flow 58 to pass through the cooling coils 53 to get from the upstream side 70 to the downstream side 72. That is, when the baffles 56 are in the closed position, inlet air flow 58 is guided to penetrate the cooling coils 53 in order to pass from the upstream side 70 to the downstream side 72, thereby achieving convective heat transfer between the air flow and the coolant in the cooling coils 53.

As in FIG. 3 and FIG. 4, the movement of the baffles 56 may be regulated manually or by a controller 40. The controller 40 may be configured to regulate the operation of the baffles 56 based on signals 43 from the controller 40 based on measurements from various sensors 42 (shown in FIG. 3), which may include sensors to measure temperature, pressure, flow rate, relative humidity, etc., upstream 70 and downstream 72 of the cooling coils 53. Based at least in part on information from these sensors 42, the controller 40 may be configured to open or close the baffles 56 between the upstream plurality of cooling coils 54 and the downstream plurality of cooling coils 52 to improve the efficiency of the gas turbine system 10. For example, the controller 40 may calculate a temperature drop from the upstream side 70 to the downstream side 72 of the chiller coil system 50 to validate or monitor the performance of the chiller coil 53. If the temperature drop is within a certain range (e.g., a threshold), the controller 40 may either change the position of the baffles 56, or it may display or otherwise relay this information to an operator, who may manage the baffles manually or using the controller 40.

To facilitate the opening or closing of the baffles 56, each may be fitted with hinges along an edge, which may allow the baffle 56 to block bypass flow paths 60 in a cooling mode, and move to a position that opens the flow paths 60 in a non-cooling mode. For example a first baffle 76 may be attached to the chiller coil 53, the chiller coil housing 55, or some other apparatus within the chiller coil system 50 with a hinge 79, hinges or some other flexible or movable attachment method along an edge 78, allowing the baffle 76 to move between open and closed positions. Dashed line 74 illustrates how the first baffle 76 may be rotated along edge 78 to move the baffle 76 to an open position, which would enable the air flow 58 to pass through the bypass flow paths 60 to flow from the upstream side 70 to the downstream side 72. Opening the first baffle 76 when the system 50 is in a non-cooling mode may reduce the pressure drop across the cooling coils 53. As described above, this may increase efficiency, thereby improving operability of the gas turbine system 10.

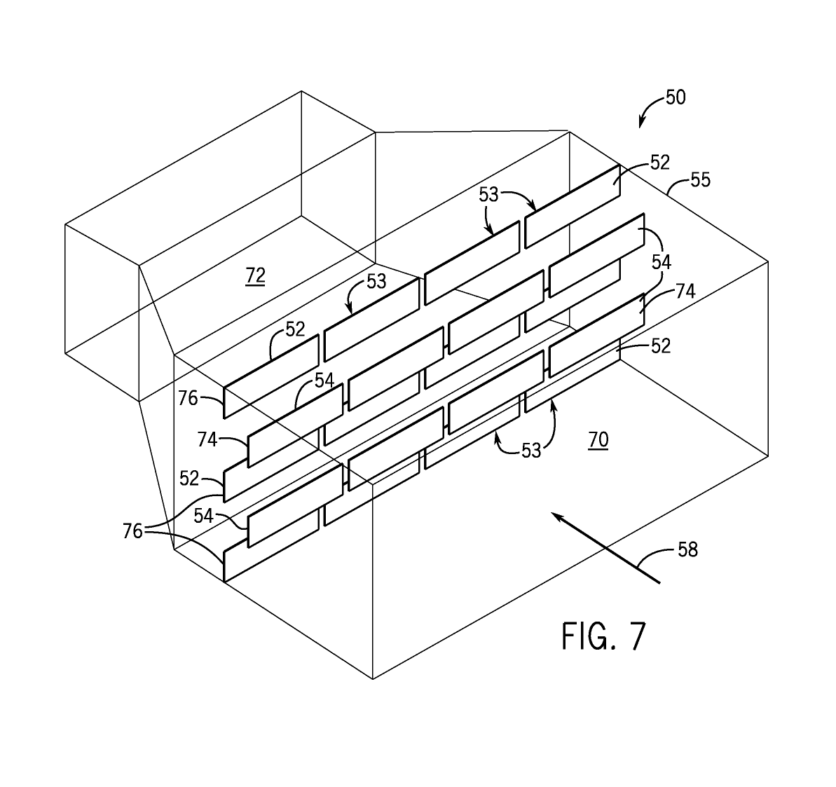

FIG. 6 is a perspective view of a partial embodiment of the downstream and upstream pluralities of cooling coils 52 and 54 and baffles 56 within the chiller coil system 50 shown in FIG. 5. Specifically, in the illustrated embodiment, the baffles 56 are shown in open positions. In other words, the baffles 56 are positioned such that the air flow 58 may pass through the upstream plurality of cooling coils 54 and the downstream plurality of cooling coils 52, and the air flow 58 may also flow through bypass flow paths 60 to pass from the upstream side 70 to the downstream side 72. When the baffles 56 are positioned such that the bypass flow paths 60 are open (e.g., when the system 50 is in a non-cooling mode), the air flow 58 may flow through the paths 60, bypassing the upstream plurality of cooling coils 54 and the downstream plurality of cooling coils 52. The air flow 58 may continue to pass through the cooling coils 53 when the chiller coil system 50 is in a non-cooling mode in order to maximize inlet air flow from the upstream side 70 to the downstream side 72.

As in FIGS. 3-5, the baffles 56 may be controlled manually or by a controller 40. The controller 40 may be configured to regulate the operation of the baffles 56 based on signals 43 from various sensors 42 (shown in FIG. 2), which may measure temperature, pressure, flow rate, relative humidity, or other operating parameter, upstream 70 and downstream 72 of the cooling coils 53. Based at least in part on information from these sensors, the controller 40 may be configured to open or close the baffles 56 between the upstream plurality of cooling coils 54 and the downstream plurality of cooling coils 52 to optimize compressor efficiency. For example, the controller 40 may calculate a temperature drop from the upstream side 70 to the downstream side 72 of the chiller coil system 50. If the temperature drop is within a certain range, the controller 40 may either change the position of the baffles 56, or it may display or otherwise relay this information to an operator, who may adjust the baffles 56 manually.

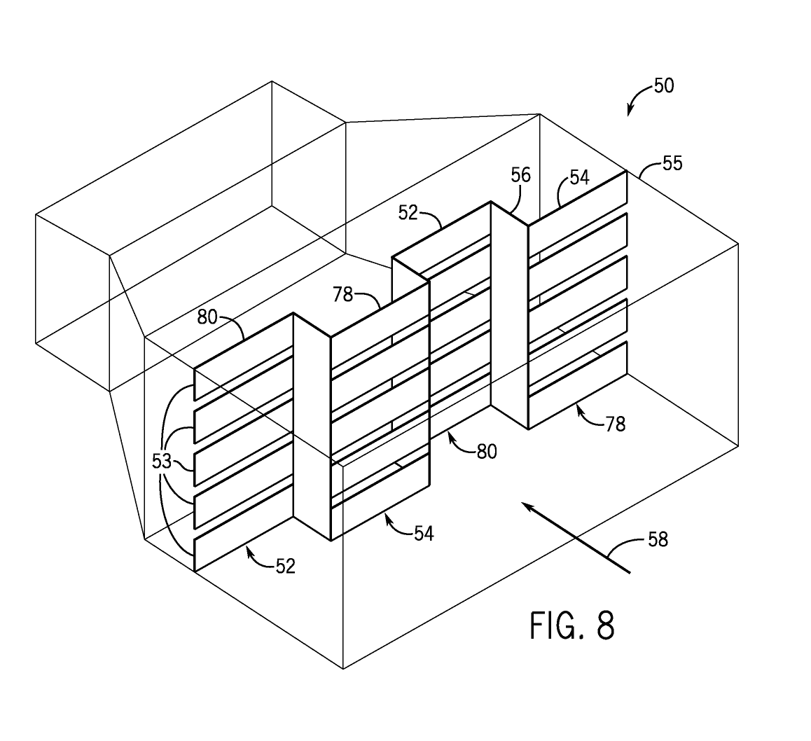

FIG. 7 is a perspective view of an embodiment of the chiller coil system 50, illustrating one arrangement of the upstream plurality of cooling coils 54 and the downstream plurality of cooling coils 52. However, for clarity purposes, the baffles 56 are not shown in the illustrated embodiment. The upstream plurality of cooling coils 54 and the downstream plurality of cooling coils 52 are arranged in horizontal rows that are staggered or alternated (e.g., by upstream and downstream). The upstream plurality of cooling coils 54 includes two rows 74, each having four cooling coils 53. The downstream plurality of cooling coils 52 includes three rows 76, each having four cooling coils 53. The rows 74 and 76 are arranged so that an upstream row 74 separates each downstream row 76 from top to bottom of the arrangement of cooling coils 53. The air flow 58 passes from the upstream side 70 to the downstream side 72 by passing through the upstream plurality of cooling coils 54 and the downstream plurality of cooling coils 52, or passing between them (e.g., when the baffles 56 are open). While this configuration includes two upstream rows 74 and three downstream rows 76, there may be additional or fewer of either. Each row, 74 or 76, may contain four cooling coils 53, as shown, or another suitable number, such as three or five. Furthermore, the number of upstream rows 74 may vary from or be equal to the number of downstream rows 76, and the number of cooling coils 53 within each row may vary from or be equal between upstream row 74 to downstream row 76. The number of cooling coils 53 and rows 74 and 76 may be determined by implementation specific parameters, such as the size of the cooling coils 53, the size of the chiller coil system housing 55, desired amount of air flow, or other parameters.

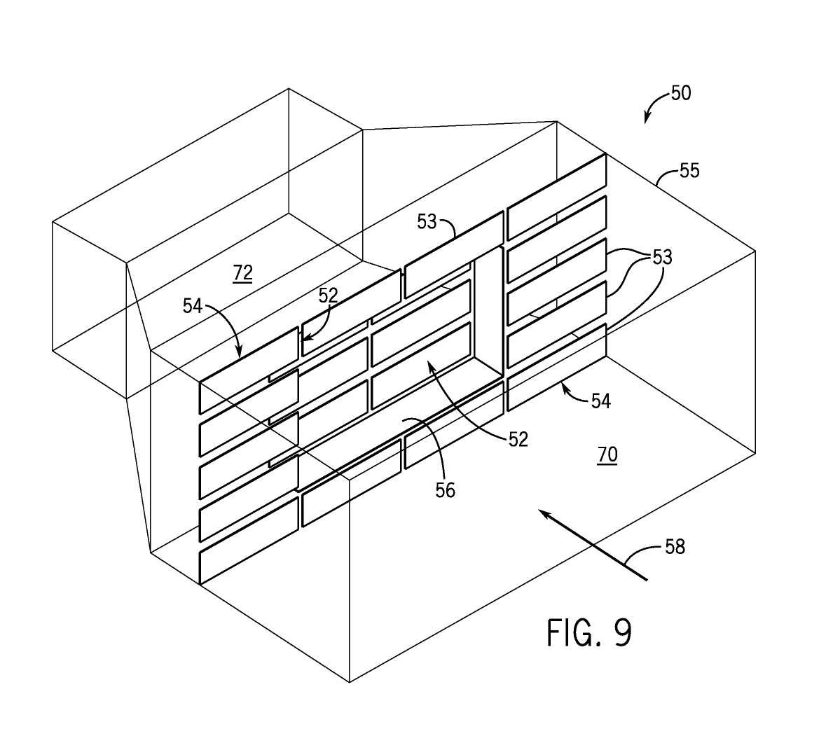

FIG. 8 shows another embodiment of an arrangement of the chiller coil system 50 in which the upstream pluralities of cooling coils 54 and the downstream pluralities of cooling coils 52 are arranged vertically in an alternating fashion. That is, the upstream and downstream cooling coils 54 and 52 are arranged in columns that are staggered. The upstream plurality of cooling coils 54 includes two columns 78, each containing five cooling coils 53. Likewise, the downstream plurality of cooling coils 52 includes two columns 80, each having five coils 53. The columns 78 and 80 are arranged in an alternating or staggered fashion, with each upstream column 78 being separated from the next upstream column 78 by a downstream column 80. Each column 78 or 80 may contain any number of cooling coils 53, such as four, six, or some other suitable number. Furthermore, the number of columns 78 and 80 is not limited to four, and in certain embodiments, the number of upstream columns 78 may not equal the number of downstream columns 80. For example, there may be three upstream columns 78 and two downstream columns 80. As in FIG. 7, the number of cooling coils 53 and columns 78 and 80 may be determined by implementation specific parameters, such as the size of the cooling coils 53, the size of the chiller coil system housing 55, a desired amount of air flow, or other parameter.

FIG. 9 shows an embodiment of an arrangement of the chiller coil system 50 in which the upstream plurality of cooling coils 54 is arranged about a perimeter of the downstream plurality of cooling coils 52. In the illustrated arrangement, the upstream plurality of cooling coils 54 includes of fourteen cooling coils 53 arranged around the perimeter of the downstream plurality of coils 52. In other words, the upstream plurality of cooling coils 54 surrounds the downstream plurality of cooling coils 52. In the illustrated embodiment, the downstream plurality of cooling coils 52 includes six cooling coils 53, arranged in a block formation that is two cooling coils 53 wide and three cooling coils 53 high. The number of cooling coils 53 in each plurality may be changed according to system specifications or preferences and limitations, such as the size of the cooling coils 53, the size of the chiller coil system housing 55, or a desired amount of air flow. As described in the previous figures, inlet air flow 58 flows from upstream side 70 to downstream side 72. In a cooling mode, the baffles 56 may be configured to block flow paths 60 between the upstream plurality of cooling coils 54 and the downstream plurality of cooling coils 52, thereby directing inlet air flow 58 to pass through the cooling coils 53 in order to chill the air flow 58. Additionally, the baffles 56 may be opened to enable the air flow 58 to bypass the cooling coils 53 by flowing through the flow paths 60, thereby reducing the pressure drop while also reducing cooling.

The disclosed embodiments include a system and method for allowing inlet air to pass through and/or bypass air conditioning coils in a gas turbine system using a plurality of movable baffles. In this manner, the air conditioning coils may not need to be moved into or out of the air intake system when changing from a cooling mode to a non-cooling mode, and vice versa. The baffles may be opened to enable air to bypass the air conditioning coils (e.g., in a non-cooling mode), and the baffles may be closed to direct air through the air conditioning coils (e.g., in a cooling mode). When in a non-cooling mode, air conditioning coils may add resistance to the airflow entering the compressor, causing a pressure drop in the inlet system which may directly affect turbine efficiency. Depending on the size of the gas turbine, the value of the pressure drop may affect the gas turbine and affect the turbine efficiency. Thus, bypassing the air conditioning coils via movable or removable baffles may enable a lower pressure drop than the level with no air bypassing, thereby improving the efficiency of the gas turbine system and reducing operation costs.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

1. A gas turbine system, comprising:
an air intake system, comprising:
a housing;
a first plurality of air conditioning coils;
a second plurality of air conditioning coils, wherein the second plurality of air conditioning coils is downstream relative to the first plurality of air conditioning coils; and
a baffle extending between each of the first and second pluralities of air conditioning coils, wherein the baffle is configured to direct an air flow through the first or second pluralities of air conditioning coils in a closed position, and the baffle is configured to enable the air flow to bypass the first and second pluralities of air conditioning coils in an opened position.

2. The gas turbine system of claim 1, wherein the first and second air conditioning coils are configured to change the air flow temperature to generate a conditioned air flow, and the air intake system is configured to supply the conditioned air flow to a compressor of the gas turbine system.

3. The gas turbine system of claim 1, wherein the baffle is configured to move from the closed position to the opened position and from the opened position to the closed position.

4. The gas turbine system of claim 3, comprising a controller configured to actuate movement of the baffle.

5. The gas turbine system of claim 4, wherein the controller is configured to actuate movement of the baffle based on feedback from a first temperature sensor upstream of the first and second pluralities of air conditioning coils, a second temperature sensor downstream of the first and second pluralities of air conditioning coils, a first pressure sensor upstream of the first and second pluralities of air conditioning coils, a second pressure sensor downstream of the first and second pluralities of air conditioning coils, or any combination thereof.

6. The gas turbine system of claim 1, wherein the air intake system comprises a drift eliminator disposed downstream of the first and second pluralities of air conditioning coils.

7. The gas turbine system of claim 1, comprising a gas turbine engine coupled to the air intake system.

8. A system, comprising:
an air intake system, comprising:
a first plurality of air conditioning coils positioned at a first axial position within a housing;
a second plurality of air conditioning coils positioned at a second axial position within the housing, wherein the second axial position is downstream of the first axial position; and
a first baffle extending between the first plurality of air conditioning coils and the second plurality of air conditioning coils, wherein the first baffle is configured to direct an air flow through the first or second pluralities of air conditioning coils in a closed position, and the first baffle is configured to enable the air flow to bypass the first and second pluralities of air conditioning coils in an opened position.

9. The system of claim 8, wherein the air intake system comprises a third plurality of air conditioning coils positioned at the first axial position within the housing, and a second baffle extending between the second plurality of air conditioning coils and the third plurality of air conditioning coils, wherein the second baffle is configured to direct the air flow through the pluralities of air conditioning coils in a closed position, and the second baffle is configured to enable the air flow to bypass the pluralities of air conditioning coils in an opened position.

10. The system of claim 9, comprising a fourth plurality of air conditioning coils positioned at the second axial position within the housing, and a third baffle extending between the third plurality of air conditioning coils and the fourth plurality of air conditioning coils, wherein the third baffle is configured to direct the air flow through the pluralities of air conditioning coils in a closed position, and the third baffle is configured to enable the air flow to bypass the pluralities of air conditioning coils in an opened position.

11. The system of claim 10, comprising a fifth plurality of air conditioning coils positioned at the first axial position within the housing, and a fourth baffle extending between the fourth plurality of air conditioning coils and the fifth plurality of air conditioning coils, wherein the fourth baffle is configured to direct the air flow through the pluralities of air conditioning coils in a closed position, and the fourth baffle is configured to enable the air flow to bypass the pluralities of air conditioning coils in an opened position.

12. The system of claim 8, wherein the first plurality of air conditioning coils is arranged horizontally, and the second plurality of air conditioning coils is arranged horizontally.

13. The system of claim 8, wherein the first plurality of air conditioning coils is arranged vertically, and the second plurality of air conditioning coils is arranged vertically.

14. The system of claim 8, wherein the second plurality of air conditioning coils is arranged about a perimeter of the first plurality of air conditioning coils.

15. The system of claim 8, wherein the air intake system comprises a housing and a filter configured to filter air flow supplied to a compressor of a gas turbine system.

16. The system of claim 8, comprising a controller, wherein the controller is configured to regulate operation of the first baffle based on information from a first temperature sensor upstream of the first and second pluralities of air conditioning coils, a second temperature sensor downstream of the first and second pluralities of air conditioning coils, a first pressure sensor upstream of the first and second pluralities of air conditioning coils, a second pressure sensor downstream of the first and second pluralities of air conditioning coils, or any combination thereof.

17. A gas turbine system, comprising:
a compressor;
an air intake system configured to supply a conditioned air flow to the compressor, the air intake system comprising:
a housing;
an air filter configured to filter an air flow;
a first plurality of air conditioning coils positioned at a first axial position within a housing, wherein the first plurality of air conditioning coils is configured to condition the air flow to generate the conditioned air flow;
a second plurality of air conditioning coils positioned at a second axial position within the housing, wherein the second axial position is downstream of the first axial position, and the second plurality of air conditioning coils is configured to condition the air flow to generate the conditioned air flow; and
a first baffle extending between the first plurality of air conditioning coils and the second plurality of air conditioning coils, wherein the first baffle is configured to direct an air flow through the first or second pluralities of air conditioning coils in a closed position, and the first baffle is configured to enable the air flow to bypass the first and second pluralities of air conditioning coils in an opened position.

18. The gas turbine system of claim 17, wherein the first plurality of air conditioning coils is arranged horizontally, and the second plurality of air conditioning coils is arranged horizontally.

19. The gas turbine system of claim 17, wherein the first baffle is configured to roll from the opened position to the closed position and from the closed position to the opened position.

20. The gas turbine system of claim 17, wherein a controller is configured to regulate operation of the first baffle based on information from a first temperature sensor upstream of the first and second pluralities of air conditioning coils, a second temperature sensor downstream of the first and second pluralities of air conditioning coils, a first pressure sensor upstream of the first and second pluralities of air conditioning coils, a second pressure sensor downstream of the first and second pluralities of air conditioning coils, or any combination thereof.
